(19) United States
(12) Patent Application Publication
(10) Pub. No.: US 2010/0255241 A1
(43) Pub. Date: Oct. 7, 2010

(54) PRESSURE-SENSITIVE ADHESIVE PRODUCT

(75) Inventors: Hiroshi WADA, Ibaraki-shi (JP); Akiko TAKAHASHI, Ibaraki-shi (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: NITTO DENKO CORPORATION, Ibaraki-shi (JP)

(21) Appl. No.: 12/752,526

(22) Filed: Apr. 1, 2010

(30) Foreign Application Priority Data
Apr. 3, 2009 (JP) 2009-090857

(51) Int. Cl. B32B 3/10

(52) U.S. Cl. 428/41.8; 428/195.1

(57) ABSTRACT

Provided is a pressure-sensitive adhesive (PSA) product having specifications in which the level of volatile organic compound emissions has been minimized, and effectively displaying those specifications. The PSA product includes a PSA layer having an adhesive face capable of attaching to an adherend, and a backing sheet disposed on a back face of the PSA layer. The PSA layer produces toluene emissions of at most 20 μg/g and produces total volatile organic compound emissions of at most 300 μg/g. The backing sheet has a mark in a color selected from green and blue displayed on a back face thereof.

### BACKGROUND OF THE INVENTION

1. Field of the Invention

The present invention relates to a pressure-sensitive adhesive product having a pressure-sensitive adhesive layer capable of attaching to an adherend.

This application claims priority from Japanese Patent Application No. 2009-090857, filed on Apr. 3, 2009, the entire contents of which are incorporated herein by reference.

2. Description of the Related Art

Pressure-sensitive adhesive (PSA) products such as double-sided PSA tape have come to be used in a variety of fields because they can be attached to adherends by pressure bonding the adhesive sides to adherends and are thus easy to work with. In recent years, the heightened awareness of environmental health has brought about a stronger desire for reductions in the amount of volatile organic compounds (VOC) released from PSA products, and specifically the amount of toluene released (toluene emissions) and the total amount of volatile organic compounds (TVOC) released (TVOC emissions), which leads to a demand for PSA products satisfying such a desire. Technical literature relating to such art includes Japanese Patent Application Publication No. 2006-111818.

### SUMMARY OF THE INVENTION

However, PSA products having reduced toluene emissions and/or TVOC emissions (i.e., low-VOC PSA products (PSA products classified as low VOCs)) tend to be higher in cost than conventional PSA products in which VOC-lowering measures (such as the use of materials or production methods suitable for reducing VOC emissions) have not been taken. Moreover, the degree and importance of VOC reduction desired in a PSA product varies with the expected applications (e.g., user, region of use, service environment) for that PSA product. For this reason, it is currently the practice to make selective use of low-VOC PSA products and conventional PSA products (products which are not low-VOC) depending on the intended application and other considerations.

Given the circumstances, it makes a lot of sense to take steps to enable someone to easily determine whether or not a PSA product is low-VOC. However, even when the packaging for a PSA product itself indicates that the product is low-VOC, because the packaging is discarded after the product has been opened, it is impossible to refer to the information on the packaging at the time the PSA product is actually used. This has the unfortunate consequence that either PSA products which are low-VOC get confused with those which are not low-VOC, or extra efforts or restrictions to prevent confusion arise. To eliminate such inconvenience, it would be desirable for PSA products to be configured in such a way that, at the time of actual use, they could easily be verified as being low-VOC. In this way, it would be possible to alleviate the burden on users of the PSA product (e.g., workers who assemble electrical appliances using such PSA products as a bonding means), and to be more accurate in making selective use of PSA products having the two different sets of specifications (low VOC and non-low VOC). It is therefore an object of the present invention to provide a PSA product which is low-VOC and on which this fact is effectively displayed.

The PSA product provided by the present invention includes a PSA layer having an adhesive face capable of attaching to an adherend, and a backing sheet disposed on a back face of the PSA layer. The PSA layer produces toluene emissions when heated at 80° C. for 30 minutes of at most 20 μg per gram of the PSA layer and produces total volatile organic compound (TVOC) emissions when heated at 80° C. for 30 minutes of at most 300 μg per gram of the PSA layer. The backing sheet has a mark in a color selected from green and blue displayed on a back face thereof.

Because this PSA product has a PSA layer which satisfies the above toluene emission and TVOC emission, it can be advantageously used in various fields, includes those fields where a large reduction in VOCs is desired. Moreover, a green and/or blue mark is displayed on the back face of the backing sheet. Because green and blue (especially green) is associated in people's minds with environmentally friendly products (products having a low burden on the environment), the PSA product can be recognized at once from its appearance as a low-VOC product. Also, given that the mark is displayed on the opposite side of the backing sheet from that in contact with the PSA layer (i.e., on the back face of the backing sheet), during use of the PSA product (such as when it is attached to an adherend or cut to a specific size), work can be carried out while checking to make sure that the PSA product is a low-VOC product. This enables the discriminating use of low-VOC PSA products versus PSA products of other specifications to be accurately made in a way that is less onerous to the user (e.g., by reducing the trouble and psychological burden of such verification).

Preferably, the mark is a combination of the color with a letter, image or symbol, or a combination thereof (hereinafter sometimes called “letters, etc.”), which indicates a low level of VOC emissions (in other words, low-VOC). In this way, the PSA product can be further verified, not only from the color but also from the information represented by letters, etc., as being a low-VOC product.

The color of the mark is preferably green. This is because green has an especially high environmentally friendly association-evoking effect. Also, it is desirable for the surface area of the mark (not including those portions that are the same color as the background) to account for at least 5% of the surface area on the back face of the backing sheet. In a preferred embodiment, the surface area of the mark is in a range of from 5 to 80%. Setting the surface area within this range increases the mark-displaying effect.

The PSA layer is preferably formed from a water-dispersed PSA composition. This PSA composition is suitable for forming a PSA layer which satisfies the toluene emissions and TVOC emissions disclosed herein.

In a preferred embodiment of the PSA product disclosed herein, the backing sheet has a front face that functions as a release face from which the back face of the PSA layer is releasable. Also, the PSA layer is constructed as a double-sided PSA sheet (PSA sheet that is adhesive on both sides) composed of a non-releasable substrate having on each side thereof a pressure-sensitive adhesive. The PSA product according to this embodiment is suitable for applications that involve the bonding of adherends (whether what is being bonded together is a plurality of adherends or one part of a single adherend to another part of the same adherend) by means of such a double-sided PSA sheet.

### BRIEF DESCRIPTION OF THE DRAWINGS

FIG. 1 is a schematic perspective view showing an embodiment of the PSA product according to the present invention;

FIG. 2 is a cross-sectional diagram taken along line II-II in FIG. 1;

FIG. 3 is a schematic cross-sectional diagram of another embodiment of the PSA product according to the present invention;

FIG. 4 is a schematic cross-sectional diagram of yet another embodiment of the PSA product according to the invention;

FIG. 5 is a schematic cross-sectional diagram of a further embodiment of the PSA product according to the invention;

FIG. 6 is a schematic cross-sectional diagram of a still further embodiment of the PSA product according to the invention; and

FIG. 7 is a schematic cross-sectional diagram of an additional embodiment of the PSA product according to the invention.

### DETAILED DESCRIPTION OF THE INVENTION

Following is a detailed description of preferred embodiments of the present invention. Note that technical matters that are required for carrying out the present invention but are not particularly mentioned in the present specification are matters of design variation that could be apprehended by a person skilled in the art based on prior art. The present invention can be carried out based on the technical details disclosed in the present specification and the drawings and on common general technical knowledge in the field in question. In the following description, members or features having like functions are designated by like symbols, and repeated explanations may be omitted or simplified.

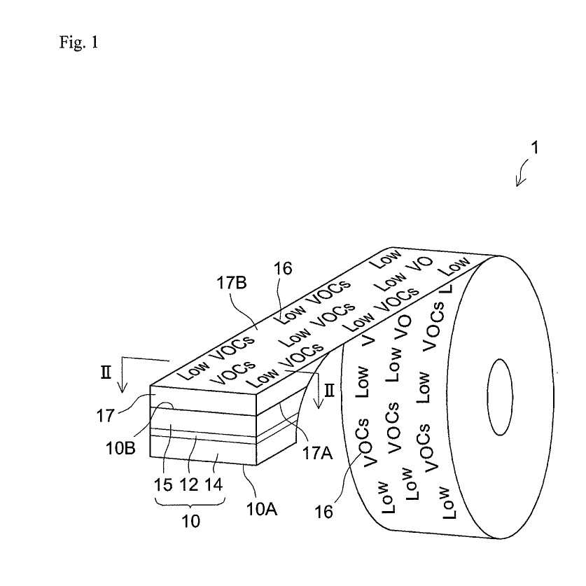

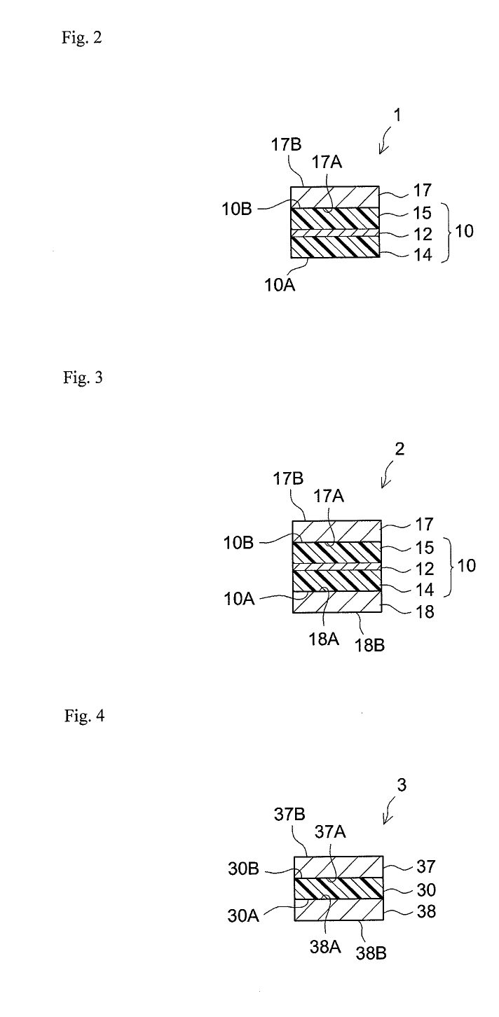

FIGS. 1 and 2 show a typical configuration of the PSA product provided by the present invention. This PSA product 1 is in the form of a roll obtained by stacking and winding together in the lengthwise direction continuous strips of a PSA layer 10 and a release liner 17. The PSA layer 10 is constructed as a double-sided PSA sheet (double-sided PSA sheet with substrate) which is composed of a sheet-like substrate (i.e., a non-releasable substrate, such as a nonwoven fabric) having a non-release face on each side thereof, and is provided on either side with PSA 14, 15. The liner 17 serves as the backing sheet in the PSA product 1 of this embodiment and has two faces—a front face 17A and a back face 17B, each of which functions as a release face (a surface having releasability). The front face 17A of the liner 17 is disposed on a back face (second adhesive face) 10B of the double-sided PSA sheet 10, thus protecting the second adhesive face 10B with the liner 17. In this roll form, the front face (first adhesive face) 10A of the double-sided PSA sheet 10 comes into contact with the back face 17B of the liner 17, as a result of which the first adhesive face 10A is also protected by the liner 17. This PSA product 1 is wound in such a way that the back face 17B of the liner 17 forms the outer peripheral side of the roll. The lettering “Low VOCs” (mark) 16, indicating that the PSA product 1 is a low-VOC product, is displayed in green and/or blue on this back face 17B (that is, on the outside surface of the roll).

The PSA product 1 is used, for example, as follows. Referring to FIG. 1, first the double-sided PSA sheet 10 and the release liner 17 stacked on the back face 10 B thereof are drawn out together from the roll of the PSA product 1. This causes the first adhesive face 10A of the double-sided PSA sheet 10 to separate from the liner back face 17B and become exposed to the exterior. At the same time, the second adhesive face 10B continues to be protected by the liner 17. The exposed first adhesive face 10A is brought into contact with a first adherend and, by pressing (such as with a hand roller) the back face 17B of the liner 17 toward the adherend side, the double-sided PSA sheet 10 can be attached to the first adherend. Here, because lettering 16 indicating that the product is a low-VOC product is displayed on the back face 17B of the liner (backing sheet) 17, a worker can proceed with the attaching operation while checking to make sure that this PSA product 1 is indeed a low-VOC product. Next, by peeling the liner 17 from the double-sided PSA sheet 10 that has been attached to the first adherend so as to expose the second adhesive face 10B, and pressing a second adherend against this second adhesive face 10B, the double-sided PSA sheet 10 can be attached to a second adherend. In this way, a first adherend and a second adherend can be bonded together through the double-sided PSA sheet 10.

Alternatively, the PSA product provided by the present invention may have cross-sectional structures like those shown in FIGS. 3 to 7. The PSA product 2 shown in FIG. 3 additionally provides, in the PSA product 1 having the cross-sectional structure shown in FIG. 2, a release liner 18 which protects the first adhesive face 10A of the PSA layer (double-sided PSA sheet with substrate) 10. The release liner 18 has at least a front face 18A serving as a release face, which front face 18A is disposed on the first adhesive face 10A. A back face 18B of the liner 18 may be either a release face or a non-release face. This PSA product 2 may be an individual sheet-type PSA product, or a PSA product in the form of a roll obtained by winding, in the lengthwise direction, continuous liners 17 and 18 together with a double-sided PSA sheet 10. The back face 17B of the release liner (backing sheet) 17 in this PSA product 2 may be either a release face or a non-release face. Lettering 16 like that in the earlier PSA product 1 (see FIG. 1) is displayed in green and/or blue on this back face 17B. By peeling off the liner 18 disposed on the front face (first adhesive face) 10A of the PSA layer 10, bringing the first adhesive face 10A thereby exposed into contact with a first adherend, and pressing the back face 17B of the liner 17 toward the adherend side, it is possible to attach the double-sided PSA sheet 10 to the first adherend while checking to make sure that the PSA product 2 is a low-VOC product.

The PSA product 3 shown in FIG. 4 has a configuration wherein the two faces 30A and 30B of a PSA layer 30 which does not have a non-releasable substrate (that is, a PSA layer which may also be thought of as a substrate-less double-sided PSA sheet; typically, a layer composed substantially of PSA) are protected by, respectively, release liners 38 and 37. At least respective faces (front faces) 37A and 38A of the liners 37 and 38 are release faces. The liners 37 and 38 have back faces 37B and 38B which may be release faces, or may be non-release faces. This PSA product 3 may be in the form of a roll or of individual sheets. In this embodiment, the release liner 37 disposed on the back face (second adhesive face) 30B of the PSA layer 30 corresponds to the backing sheet. Lettering 16 similar to that in the earlier PSA product 1 (see FIG. 1) is displayed in green and/or blue on the back face 37B of this liner 37. By peeling off the liner 38 disposed on the front face (first adhesive face) 30A of the PSA layer 30, bringing the first adhesive face 30A thereby exposed into contact with a first adherend, then pressing the back face 37B of the liner 37 protecting the second adhesive face 30B toward the adherend side, it is possible to attach the PSA layer 30 to the first adherend while checking to make sure that the PSA product 3 is a low-VOC product.

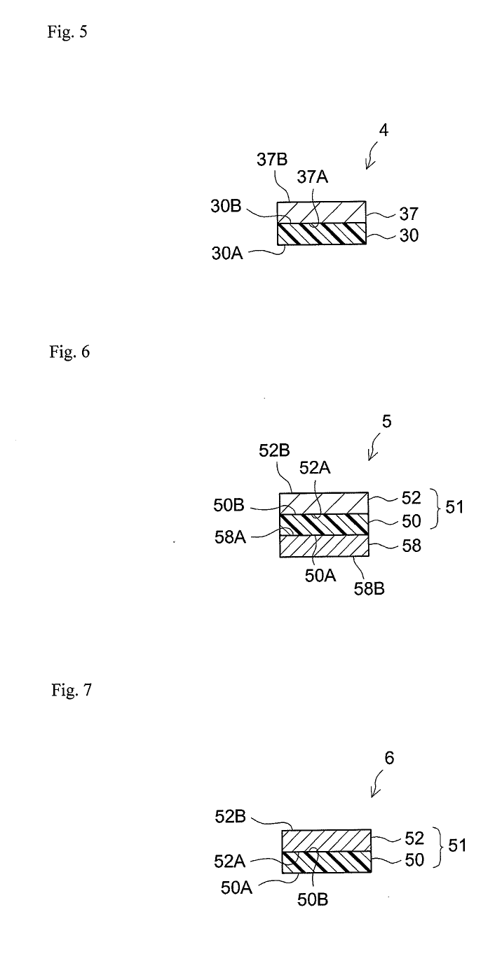

The PSA product 4 shown in FIG. 5 has a release liner (backing sheet) 37, each side 37A and 37B of which is a release face, disposed on a back face (second adhesive face) 30B of a PSA layer 30 like that in the PSA product 3 of the preceding embodiment. The front face 37A of the liner 37 is into contact with the second adhesive face 30B, thereby protecting the second adhesive face 30B. Winding up this PSA product 4 brings the first adhesive face 30A into contact with the back face 37B of the liner 37, thereby enabling a configuration wherein the first adhesive face 30A also is protected by the liner 37 to be achieved. This PSA product 4 will typically be provided in the form of a roll obtained by winding up a continuous liner 37 and a continuous PSA layer 30 in the lengthwise direction such that the back face 37B of the liner 37 becomes the outer peripheral side. Lettering 16 like that in the above-described PSA product 1 (see FIG. 1) is displayed in green and/or blue on this back face 37B. By bringing the first adhesive face 30A into contact with a first adherend and pressing the back face 37B of the liner 37 toward the adherend side, it is possible to attach the double-sided PSA sheet 30 to the first adherend while checking to make sure that the PSA product 4 is a low-VOC product.

In contrast with above PSA products 1 to 4, which are each examples of PSA products having a double-sided PSA layer (i.e., wherein each side of the PSA layer is an adhesive face capable of being attached to an adherend), the PSA products 5 and 6 shown in FIGS. 6 and 7 are examples of PSA products having a single-sided PSA layer. In the PSA product 5 shown in FIG. 6, the back face 50B of the PSA layer 50 is in contact with a backing sheet 52 wherein at least a front face (surface on PSA layer side) 52A thereof is a non-release face. Thus the backing sheet (supportive substrate) 52 and the PSA layer 50 together make up a single-sided PSA sheet 51. The front face (adhesive face) 50A of the PSA layer 50 is protected by a release liner 58 wherein at least a front face (surface on PSA layer side) 58A thereof is a release face. This PSA product 5 may be either a single sheet-type product or may be in the form of a roll-type product obtained by winding together in the lengthwise direction a continuous PSA sheet 51 and a continuous release liner 58. The back face 52B of the backing sheet 52 in the PSA product 5 may be either a release face or a non-release face. Lettering 16 like that in the above-described PSA product 1 (see FIG. 1) is displayed in green and/or blue on the back face 52B. By peeling off the liner 58 disposed on the front face (adhesive face) 50A of the PSA layer 50, bringing the adhesive face 50A thus exposed into contact with an adherend and pressing the back face 52B on the backing sheet 52 toward the adherend side, it is possible to attach the PSA sheet 51 to the adherend while checking to make sure that the product is a low-VOC product.

In the PSA product 6 shown in FIG. 7, the back face 50B of a PSA layer 50 like that in the foregoing PSA product 5 is bonded to a backing sheet 52 having a front face 52A that is a non-release face and a back face 52B that is a release face. Winding up this PSA product 6 brings the adhesive face 50A into contact with the back face 52B of the backing sheet 52, thereby protecting the adhesive face 50A. The PSA product 6 is constructed as a single-sided PSA sheet 51 composed of such a backing sheet (backing substrate) 52 and PSA layer 50, and is typically provided as a roll-type product obtained by winding up in the lengthwise direction a continuous PSA sheet 51 so that the back face 52B of the backing sheet 52 forms the outer peripheral side of the roll. Lettering 16 like that in the earlier described PSA product 1 (see FIG. 1) is displayed in green and/or blue on the back face 52B. By bringing the adhesive face 50A into contact with an adherend and pressing the back face 52B of the backing sheet 52 toward the adherend side, it is possible to attach the PSA sheet 51 to the adherend while checking to make sure that the product is a low-VOC product.

The PSA product disclosed herein is characterized in that a mark in a color selected from green and blue is displayed on the back face of the backing sheet. As used herein, “displayed on the back face of the backing sheet” means that the mark is visible when the PSA product is viewed from the back face side of the backing sheet. No limitation is imposed on the manner in which the mark is applied from the outside to the back face of the backing sheet (e.g., the manner in which the mark is printed onto the back face of the backing sheet). For example, in the case of a backing sheet having a multilayer structure, the mark may be printed onto the back face side of one of the layers, and one or more transparent or translucent layer provided on the back face side thereof. The method of providing the mark is not subject to any particular limitation. Generally, it is preferable to use a method that involves printing the mark. Various known or conventional methods, such as offset printing, silk screen printing, letterpress printing, flexography or gravure printing, may be suitably employed as the printing method.

The mark is typically a combination of a green and/or blue color with letters, etc. (e.g., letters, images or symbols, or combinations thereof), and may be a mark that combines also a three-dimensional shape such as embossing. In a preferred embodiment, the information represented by the letters, etc. includes at least information pertaining to the low-VOC specifications (typically, information indicating that the PSA product has been subjected to VOC-reducing measures). By combining letters, etc. representing information relating to low VOCs with a green and/or blue color, a mark can be achieved which more effectively conveys such information to the viewer. Such low-VOC-related information may be, for example, lettering which briefly indicates that the product is a low-VOC product (a typical example being an expression of one or more words which conveys the meaning ‘low VOCs’ as in the case of the lettering 16 shown in FIG. 1), such lettering that has been stylized in varying degrees, known marks indicating that the product is low-VOC, letters specifically indicating the emissions of organic compounds (e.g., toluene emissions, TVOC emissions), and combinations of one or more thereof.

The information indicated by such letters, etc. may additionally be information pertaining to, for example, product name, name of manufacturer, specifications (which may be information relating to specifications other than the low-VOC specifications, or may be more detailed information relating to the low-VOC specifications), method of use, recycling-related information, date of manufacture, product number (lot number), expiration date of use, service life, logo marks, and product component (pressure-sensitive adhesive, release liner, non-releasable substrate, etc.) materials or types, as well as ingredient types and contents therein. Examples of recycling-related information include resource name, resource recycling mark, details on whether the substrate and pressure-sensitive adhesive in double-sided PSA tape is resource recyclable or not, information on the method of disposal, and details on whether the PSA product components (e.g., release liner) can be incinerated or not. Preferred examples of information displayed in addition to information concerning low VOCs include the fact that the product is a PSA product for which environmental measures have been taken (e.g., the fact that at least some of the components in the PSA product can be incinerated, or are biodegradable when buried in soil), the fact that the PSA product was manufactured using a solvent-free PSA composition (water-based PSA composition, UV-curable PSA composition, etc.), and the fact that the PSA product was manufactured using a PSA composition of the adhesive ingredients dissolved in an organic solvent (preferably an organic solvent containing substantially no aromatic hydrocarbon solvent, such as ethyl acetate). By combining letters, etc. indicating such information with a green and/or blue color, a mark can be obtained which more effectively conveys this information to the viewer.

In the art disclosed herein, “blue” refers to wavelengths in the visible spectrum of at least 360 nm but less than 480 nm, and “green” refers to wavelengths in the visible spectrum of at least 480 nm but less than 560 nm. The color making up the mark may be a single color or may be two or more colors differing in at least one of the color attributes of hue, lightness and saturation. From the standpoint of production costs, a mark composed of a single color (most preferably green) is preferred. The color of the back face on the backing sheet in areas other than the mark (i.e., the background color) is preferably a color that makes the shape of the mark readily distinguishable. In order to make the mark more recognizable, it is advantageous to use as the background color a color in which at least one of the color attributes of hue, lightness and saturation is very different from that of the color forming the mark. For example, it is preferable to use a bright, pale color such as white, cream or yellow as the background color. From the standpoint of production costs, making the background color white is especially preferred. When paper (e.g., wood-free paper, glassine) is used as the backing sheet, or when paper having a transparent or translucent resin (e.g., polyethylene) laminated on at least one side thereof is used for this purpose, the color of the backing sheet itself may be advantageously used as the background color.

The size of the mark is preferably at least 1 mm×1 mm, more preferably at least 1.5 mm×1.5 mm, and even more preferably at least 2 mm×2 mm. In cases where the mark contains letters (including cases where the mark is composed entirely of lettering), it is desirable for at least one half of the letters to have a size of preferably at least 1 mm×1 mm (more preferably at least 1.5 mm×1.5 mm, and even more preferably at least 2 mm×2 mm). If the mark is too small in size, the efficiency with which information is conveyed by the letters, etc. will tend to decrease. There is no particular upper limit in the size of the mark, so long as the size enables the information displayed by the letters, etc. to be recognized during actual use of the PSA product (e.g., during attachment to an adherend) in the intended application.

The color of the mark in the art disclosed herein is typically composed of green and/or blue alone (preferably green alone), or may be composed of green and/or blue (preferably green) together with the background color. The surface area of the mark (not including the surface area of regions of the same color as the background color) as a percentage of the surface area of the back face of the backing sheet may be set to, for example, at least 5% (typically at least 5% but not more than 80%), and is preferably set to at least 5% but not more than 60%, and more preferably set to at least 5% but not more than 50%. If the surface area percentage occupied by the marks is too small, each mark may be too small and difficult to see, or the spacing interval between individual marks may become so wide that places where no mark is present may arise during actual use. On the other hand, if the surface area percentage occupied by the marks is too large, it becomes difficult to understand what is written (the recognizability of the letters, etc. decreases).

In the PSA product provided by the art disclosed herein, the PSA layer has toluene emissions when heated at 80° C. for 30 minutes (also referred to below simply as “toluene emissions”) of 20 μg per gram of the PSA layer (this is also abbreviated below as “20 μg/g”) or less. In a preferred embodiment, the toluene emissions of the PSA layer is 10 μg/g or less, and especially 5 μg/g or less. There is no particular lower limit in the toluene emissions, although a level of substantially zero (below the limit of detection) is desirable. Taking into account such factors as the adhesive properties, productivity, the substrate and backing sheet materials that may be selected, and the drying conditions for the PSA composition, from the standpoint of practical use and production, the PSA layer may have toluene emissions of from about 0.5 to about 20 μg/g (e.g., from 0.5 to 10 μg/g, and preferably from 0.5 to 5 μg/g). The toluene emissions referred to herein are values obtained by the following measurement method.

### Method of Measuring Toluene Emissions

A specimen containing a PSA layer of a given size (e.g., having a surface area of 5 cm²) is placed in a vial and sealed. This vial is heated at 80° C. for 30 minutes and, using a head space autosampler, 1.0 mL of gas in a heated state is injected into a gas chromatograph (GC) and the amount of toluene is measured. The amount of toluene generated (emissions) per gram of the PSA layer in the specimen (μg/g) is calculated from the measurement results. In cases where, as shown in FIGS. 1 and 2, for example, the PSA layer is a double-sided PSA sheet in the form of a non-releasable substrate having PSA on each side thereof, the weight of the PSA layer serving here as the basis for calculating the toluene emissions per gram of the PSA layer is the total weight of the PSA layer, including the PSA and the non-releasable substrate.

In addition, the PSA product of the present invention has TVOC emissions when the PSA layer is heated at 80° C. for 30 minutes (also referred to below simply as “TVOC emissions”) of 300 μg or less per gram of the PSA layer. This TVOC is preferably about 150 μg/g or less, more preferably about 100 μg/g or less, and even more preferably about 50 μg/g or less. There is no particular lower limit in the TVOC emissions, although a level of substantially zero (below the limit of detection) is desirable. Taking into account such factors as the adhesive properties, production efficiency, the substrate and backing sheet materials that may be selected, and the drying conditions for the PSA composition, from the standpoint of practical use and production, the PSA layer may have TVOC emissions of from about 5 to about 300 μg/g (e.g., from 5 to 150 μg/g, preferably from 5 to 100 μg/g, and more preferably from 5 to 50 μg/g). The TVOC emissions referred to herein are values obtained by the following measurement method.

### Method of Measuring TVOC Emissions

A vial in which a specimen like that used in the toluene emissions measurement method has been placed is heated at 80° C. for 30 minutes and, using a head space autosampler, 1.0 mL of gas in a heated state is injected into a gas chromatograph. Based on the gas chromatogram obtained, peak assignments and quantitative determinations are carried out for the volatile compounds predicted from the materials used in fabricating the PSA layer (e.g., monomers used to synthesize the acrylic polymer, solvents used to prepare the subsequently described tackifying resin emulsion), toluene-equivalent determinations are carried out for other (difficult to assign) peaks, and the level of TVOC emissions per gram of PSA layer in the specimen (μg/g) is determined from these results. In cases where, as shown in FIGS. 1 and 2, for example, the PSA layer is a double-sided PSA sheet in the form of a non-releasable substrate having PSA on each side thereof, the weight of the PSA layer serving here as the basis for calculating the TVOC emissions per gram of the PSA layer is the total weight of the PSA layer, including the PSA and the non-releasable substrate.

The gas chromatography measurement conditions, both for the method of measuring toluene emissions and the method of measuring TVOC emissions, were as follows.
Column: DB-FFAP, 1.0 μm (0.535 mm diameter×30 m)
Carrier gas: Helium, 5.0 mL/min
Column head pressure: 23 kPa (40° C.)
Injection port: Split (split ratio, 12:1; temperature, 250° C.)
Column temperature: 40° C. (0 min)−<+10° C./min>−250 (9 min) (meaning that the temperature was ramped up at a rate of 10° C./min from 40° C. to 250° C., then held at 250° C. for 9 minutes)
Detector: FID (temperature, 250° C.)

In a preferred embodiment of the art disclosed herein, the PSA in the PSA layer which satisfies the above toluene emissions and TVOC emissions (also referred to below as the “low-VOCs PSA layer”) is made from an aqueous PSA composition. As used herein, “aqueous PSA composition” refers to a composition containing an adhesive ingredient in an aqueous medium (the solvent making up this medium is water or a mixed solvent composed primarily of water (aqueous solvent)). Water-dispersed (emulsion-type) PSA compositions in the form of an adhesive ingredient dispersed in an aqueous medium are typical examples of such aqueous PSA compositions. Other examples of aqueous PSA compositions include aqueous solution-type PSA compositions in the form of an adhesive ingredient dissolved in an aqueous medium.

The adhesive ingredient may be a substance containing as the base polymer any of various known polymers capable of forming a PSA, such as acrylic, rubber, polyester, urethane, polyether, silicone, polyamide and fluorinated polymers. As used herein, “base polymer” refers to a polymer serving as the basic ingredient of the PSA, and is typically the chief ingredient of the polymer ingredients included in the PSA. Preferred examples of the PSA composition in the art disclosed herein include aqueous PSA compositions wherein the chief ingredient of the polymer ingredients included in the PSA is an acrylic polymer. Of these, an emulsion-type composition of the above acrylic polymer dispersed in water (acrylic emulsion-type PSA composition) is preferred.

The acrylic emulsion-type PSA composition includes a water-dispersed acrylic polymer. This water-dispersed acrylic polymer is a composition in the form of an emulsion of an acrylic polymer dispersed in water. In the art disclosed herein, this acrylic polymer may be used as the base polymer of the PSA (the base ingredient of the PSA) in the PSA layer. For example, it is preferable for the acrylic polymer to account for at least 50 wt % of the PSA. This acrylic polymer is preferably one in which an alkyl (meth)acrylate serves as the chief monomeric ingredient (i.e., an ingredient which accounts for at least 50 wt % of the total amount of monomer making up the acrylic polymer).

In this specification, “(meth)acrylate” refers collectively to acrylate and methacrylate. Similarly, “(meth)acryloyl” refers collectively to acryloyl and methacryloyl, and “(meth)acryl” refers collectively to acryl and methacryl.

Preferred use may be made of a compound of Formula (I) below as the alkyl (meth)acrylate.

CH₂═C(R¹)COOR² (1)

In Formula (1), R¹ is a hydrogen or methyl, and R² is an alkyl having from 1 to 20 carbon atoms. Illustrative examples of R² include alkyl groups such as methyl, ethyl, propyl, isopropyl, butyl, isobutyl, s-butyl, t-butyl, pentyl, isoamyl, neopentyl, hexyl, heptyl, octyl, isooctyl, 2-ethylhexyl, nonyl, isononyl, decyl, isodecyl, undecyl, dodecyl, tridecyl, tetradecyl, pentadecyl, hexadecyl, heptadecyl, octadecyl, nonadecyl and eicosyl. From the standpoint of such considerations as the storage elastic modulus, an alkyl (meth)acrylate in which R² is an alkyl having from 2 to 14 carbon atoms (such a range in the number of carbon atoms is sometimes indicated below as “C₂₋₁₄”) is preferred, and an alkyl (meth)acrylate in which R² is a C₂₋₁₀ alkyl is more preferred. Especially preferred examples of R² are butyl and 2-ethylhexyl.

In one preferred embodiment, at least about 50 wt % (more preferably at least 70 wt %, such as about 90 wt % or more) of the total amount of alkyl (meth)acrylate used to synthesize the acrylic polymer is an alkyl (meth)acrylate in which R² in Formula (1) is C₂₋₁₄ (preferably C₂₋₁₀, and more preferably C₄₋₈). With such a monomer makeup, an acrylic polymer having a storage elastic modulus near room temperature that falls within a highly suitable range can easily be obtained. Substantially all of the alkyl (meth)acrylate used may be C₂₋₁₄ alkyl (meth)acrylate.

The alkyl (meth)acrylate making up the acrylic polymer in the art disclosed herein may be butyl acrylate (BA) alone, 2-ethylhexyl acrylate (2EHA) alone, or a combination of BA and 2EHA. When a combination of BA and 2EHA is used as the alkyl (meth)acrylate, the relative proportions thereof are not subject to any particular limitation. For example, advantageous use may be made of relative proportions wherein at least about 40 wt % (e.g., about 45 to about 95 wt %) of the combined amount of BA and 2EHA is 2EHA.

Monomer ingredients in the acrylic polymer may also include, within a range such that an alkyl (meth)acrylate is the chief ingredient, other monomers that are copolymerizable with the alkyl (meth)acrylate (also referred to below as “copolymerizable monomer ingredients”). The proportion of alkyl (meth)acrylate relative to the overall amount of monomer ingredients making up the acrylic polymer may be set to at least about 80 wt % (typically, from 80 to 99.8 wt %), and preferably at least 85 wt % (e.g., from 85 to 99.5 wt %). The proportion of the alkyl (meth)acrylate may be at least 90 wt % (e.g., from 90 to 99 wt %).

The copolymerizable monomer ingredients may be useful for introducing crosslink points into the acrylic polymer or for increasing the cohesive strength of the acrylic polymer. These copolymerizable monomers may be used singly or as combinations of two or more thereof.

More specifically, various functional group-containing monomer ingredients may be used as copolymerizable monomer ingredients for introducing crosslink points into the acrylic polymer (these are typically thermally crosslinkable functional group-containing monomer ingredients for introducing into the acrylic polymer crosslink points that crosslink under the effect of heat). By using such functional group-containing monomer ingredients, the bond strength with respect to the adherend can be enhanced. Such functional group-containing monomer ingredients are not subject to any particular limitation, provided they are monomer ingredients which are copolymerizable with alkyl (meth)acrylate and are capable of providing functional groups that will serve as crosslink points. For example, functional group-containing monomer ingredients such as those mentioned below may be used singly or as combinations of two or more thereof.

Carboxyl group-containing monomers: e.g., ethylenically unsaturated monocarboxylic acids such as acrylic acid, methacrylic acid and crotonic acid; ethylenically unsaturated dicarboxylic acid such as maleic acid, itaconic acid and citraconic acid, as well as anhydrides thereof (e.g., maleic anhydride, itaconic anhydride).

Hydroxyl group-containing monomers: e.g., hydroxyalkyl (meth)acrylates such as 2-hydroxyethyl (meth)acrylate, 2-hydroxypropyl (meth)acrylate, 3-hydroxypropyl (meth)acrylate and 2-hydroxybutyl (meth)acrylate; and unsaturated alcohols such as vinyl alcohol and allyl alcohol.

Amide group-containing monomers: e.g., (meth)acrylamide, N,N-dimethyl (meth)acrylamide, N-butyl (meth)acrylamide, N-methylol (meth)acrylamide, N-methylolpropane (meth)acrylamide, N-methoxymethyl (meth)acrylamide and N-butoxymethyl (meth)acrylamide.

Amino group-containing monomers: e.g., aminoethyl (meth)acrylate, N,N-dimethylaminoethyl (meth)acrylate and t-butylaminoethyl (meth)acrylate.

Epoxy group-containing monomers: e.g., glycidyl (meth)acrylate, methylglycidyl (meth)acrylate and allyl glycidyl ether.

Cyano group-containing monomers: e.g., acrylonitrile, methacrylonitrile.

Keto group-containing monomers: e.g., diacetone (meth)acrylamide, diacetone (meth)acrylate, vinyl methyl ketone, vinyl ethyl ketone, allyl acetoacetate and vinyl acetoacetate.

Nitrogen heterocyclic ring-containing monomers: e.g., N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-vinylmorpholine, N-vinylcaprolactam and N-(meth)acryloylmorpholine.

Alkoxysilyl group-containing monomers: e.g., 3-(meth)acryloxypropyltrimethoxysilane, 3-(meth)acryloxypropyltriethoxysilane, acryloxypropyltriethoxysilane, 3-(meth)acryloxypropylmethyldimethoxysilane and 3-(meth)acryloxypropylmethyldiethoxysilane.

Of such functional group-containing monomer ingredients, preferred use may be made of one or more selected from among carboxyl group-containing monomers and acid anhydrides thereof. Substantially all of the functional group-containing monomer ingredients may be carboxyl group-containing monomers. Of these, examples of preferred carboxyl group-containing monomers include acrylic acid and methacrylic acid. One of these may be used alone, or acrylic acid and methacrylic acid may be used together in any ratio.

It is advantageous to use the above functional group-containing monomer ingredient in a range of up to about 12 parts by weight (e.g., from about 0.5 to about 12 parts by weight, and preferably from about 1 to about 8 parts by weight) per 100 parts by weight of the alkyl (meth)acrylate. If the amount of functional group-containing monomer ingredient used is too high, the cohesive strength may become excessive, as a result of which the adhesive properties (e.g., adhesive strength) may tend to decline.

To increase the cohesive strength of the acrylic polymer, additional use may be made of copolymerizable ingredients other than the above functional group-containing monomers. Illustrative examples of such copolymerizable ingredients include vinyl ester monomers such as vinyl acetate and vinyl propionate; aromatic vinyl compounds such as styrene, substituted styrenes (e.g., α-methylstyrene) and vinyltoluene; nonaromatic ring-containing (meth)acrylates such as cycloalkyl (meth)acrylates (e.g., cyclohexyl (meth)acrylate, cyclopentyl di(meth)acrylate) and isobornyl (meth)acrylate; aromatic ring-containing (meth)acrylates such as aryl (meth)acrylates (e.g., phenyl (meth)acrylate), aryloxyalkyl (meth)acrylates (e.g., phenoxyethyl (meth)acrylate) and arylalkyl (meth)acrylates (e.g., benzyl (meth)acrylate); olefinic monomers such as ethylene, propylene, isoprene, butadiene and isobutylene; chlorinated monomers such as vinyl chloride and vinylidene chloride; isocyanate group-containing monomers such as 2-(meth)acryloyloxyethyl isocyanate; alkoxy group-containing monomers such as methoxyethyl (meth)acrylate and ethoxyethyl (meth)acrylate; and vinyl ether monomers such as methyl vinyl ether and ethyl vinyl ether.

Other examples of copolymerizable monomer ingredients include monomers having a plurality of functional groups in a molecule. Illustrative examples of such polyfunctional monomers include 1,6-hexanediol di(meth)acrylate, ethylene glycol di(meth)acrylate, diethylene glycol di(meth)acrylate, triethylene glycol di(meth)acrylate, tetraethylene glycol di(meth)acrylate, (poly)ethylene glycol di(meth)acrylate, propylene glycol di(meth)acrylate, (poly)propylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, glycerol di(meth)acrylate, epoxy acrylate, polyester acrylate, urethane acrylate, divinylbenzene, butyl di(meth)acrylate and hexyl di(meth)acrylate.

A known or conventional polymerization method may be employed as the method of polymerizing such monomers to obtain a water-dispersed acrylic polymer. Preferred use may be made of an emulsion polymerization process. When carrying out emulsion polymerization, suitable use may be made of monomer feed methods such as a batch charging method in which all the monomer starting material is fed at one time, a continuous feed (dropwise addition) method, or a divided feed (dropwise addition) method. Alternatively, part or all (typically all) of the monomer may be mixed beforehand with water (typically, a suitable amount of the subsequently described emulsifier is used together with water) and emulsified, and the resulting emulsified liquid (monomer emulsion) then fed batchwise, continuously, or in divided portions to the interior of the reaction vessel. The polymerization temperature may be selected as appropriate for the types of monomers used, the type of polymerization initiator, etc. For example, the polymerization temperature may be set to from about 20 to about 100° C. (typically from about 40 to about 80° C.).

The polymerization initiator used at the time of polymerization may be suitably selected, according to the type of polymerization method, from among known or conventional polymerization initiators. For example, in the emulsion polymerization method, preferred use may be made of an azo-type polymerization initiator. Illustrative examples of azo-type polymerization initiators include 2,2′-azobisisobutyronitrile, 2,2′-azobis(2-methylpropionamidine) disulfate, 2,2′-azobis(2-amidinopropane) dihydrochloride, 2,2′-azobis[2-(5-methyl-2-imidazolin-2-yl)propane] dihydrochloride, 2,2′-azobis(N,N′-dimethyleneisobutylamidine), 2,2′-azobis[N-(2-carboxyethyl)-2-methylpropionamidine] hydrate, 2,2′-azobis(4-methoxy-2,4-dimethylvaleronitrile), 2,2′-azobis(2,4-dimethylvaleronitrile), 2,2′-azobis(2-methylbutylonitrile), 1,1′-azobis(cyclohexane-1-carbonitrile), 2,2′-azobis(2,4,4-trimethylpentane) and dimethyl-2,2′-azobis(2-methylpropionate).

Further examples of polymerization initiators includes persulfates such as potassium persulfate and ammonium persulfate; peroxide initiators such as benzoyl peroxide, t-butyl hydroperoxide, di-t-butyl peroxide, t-butyl peroxy benzoate, dicumyl peroxide, 1,1-bis(t-butylperoxy)-3,3,5-trimethylcyclohexane, 1,1-bis(t-butylperoxy)cyclododecane and hydrogen peroxide; substituted ethane initiators such as phenyl-substituted ethane; and aromatic carbonyl compounds. Still further examples of polymerization initiators include redox initiators due to a combination of a peroxide and reducing agent. Examples of such redox initiators include combinations of peroxides with ascorbic acid (e.g., the combination of an aqueous hydrogen peroxide solution with ascorbic acid), combinations of peroxides with ferric salts (e.g., combination of an aqueous hydrogen peroxide solution with a ferric salt), and combinations of persulfates with sodium bisulfite.

Such polymerization initiators may be used singly or as a combination of two or more types. The amount in which the initiator is used may be selected from a range of, for example, from about 0.005 to about 1 part by weight (typically from 0.01 to 1 part by weight) per 100 parts by weight of all the monomer ingredients, provided it is an ordinary amount for this purpose. If the amount of the polymerization initiator is too large or too small, the desired adhesive performance may be difficult to achieve.

A chain transfer agent (which may also be thought of as a molecular weight modifier or a degree of polymerization regulator) may be optionally used in polymerization. Known or conventional chain transfer agents may be used as the chain transfer agent; illustrative examples include mercaptans such as dodecyl mercaptan (dodecanethiol), lauryl mercaptan, glycidyl mercaptan, 2-mercaptoethanol, mercaptoacetic acid, 2-ethylhexyl thioglycolate and 2,3-dimethylcapto-1-propanol; and also α-methyl styrene dimer. Such chain transfer agents may be used singly or as a combination of two or more thereof. The amount in which the chain transfer agent is used may be selected from a range of, for example, from about 0.001 to about 0.5 part by weight per 100 parts by weight of the monomer starting material, provided it is an amount of about the same degree as generally used.

In the art disclosed herein, in a preferred embodiment in which the monomer starting materials are emulsion polymerized, the monomer starting material is fed to a reaction vessel containing the polymerization initiator and a polymerization reaction is carried out on the monomer starting material by keeping the system at a polymerization temperature (preferably from about 40 to about 80° C., such as from about 50 to about 70° C.) higher than room temperature. The contents of the reaction vessel (the reaction mixture) are then typically cooled to room temperature. For example, the entire amount of monomer starting material may be fed all at once to the reaction vessel in which all of the polymerization initiator has been charged, the entire amount of monomer starting material may be fed continuously over a given period of time (continuous feeding), or the entire amount of monomer starting material may be divided into several portions and fed at given time intervals (e.g., from about 5 to about 60 minutes) (divided feeding). In cases where the continuous feeding of the monomer starting material is carried out, it is generally suitable to set the time during which feeding is carried out to from about 1 hour to about 8 hours, and preferably from about 2 hours to about 6 hours (e.g., from about 3 hours to about 5 hours). In cases where the divided feeding of the monomer starting material is carried out, it is generally suitable to set the time from when the initial fraction of the monomer starting material is fed to when the final fraction of the monomer starting material is fed to from about 1 hour to about 8 hours, and preferably from about 2 hours to about 6 hours (e.g., from about 3 hours to about 5 hours). Alternatively, it is possible to feed at least part of the monomer starting material into a reaction vessel wherein part of the polymerization initiator has been charged so as to initiate polymerization of the monomer starting material, and either feed the remainder of the polymerization initiator continuously over a given period of time or divide it into several portions and feed those portions at given time intervals. It is generally desirable to end the feeding of the polymerization initiator at substantially the same time as the feeding of the monomer starting material is ended or prior to ending the feeding of the monomer starting material.

The polymerization time (which refers to the time during which the polymerization reaction is carried out on the monomer starting material, and may be thought of as the length of time the system is held at the polymerization temperature, starting when the polymerization reaction is initiated) may be suitably set according to such factors as the type of polymerization initiator used, the polymerization temperature, and the manner in which the polymerization initiator and the monomer starting material are fed. For example, the polymerization time may be set to from about 2 hours to about 12 hours; from the standpoint of productivity and other considerations, it is generally preferable to set the polymerization time to from about 4 hours to about 8 hours. Also, it is preferable to hold the contents of the reaction vessel (the reaction mixture) at the polymerization temperature (i.e., to carry out maturation or aging) for a given period of time after feeding of the entire amount of the monomer starting material to the reaction vessel has been completed. By carrying out such maturation, the amount of monomer remaining in the reaction mixture can be reduced, making it possible to obtain an acrylic polymer capable of forming a PSA layer having lower TVOC emissions. This maturation period may be set to, for example, from about 30 minutes to about 4 hours; from the standpoint of productivity and other considerations, it is generally preferable to set the maturation period to from about 1 hour to about 3 hours. As used herein, “polymerization time” includes the maturation period. Therefore, in a case where, for example, a reaction vessel which has been charged with the entire amount of polymerization initiator is held at the polymerization temperature and the entire amount of the monomer starting material is charged continuously therein over a period of 4 hours, and the reaction mixture is subjected to maturation by continuing to hold the system at the polymerization temperature for 2 hours after feeding of the monomer starting material has been completed, the polymerization time is 6 hours. The polymerization temperature may be constant over the entire period of the polymerization time, or may differ in a portion of the period relative to the rest of the period. For example, after the monomer starting material has been fed at a given polymerization temperature, maturation may be carried out at a higher polymerization temperature.

In a preferred embodiment for emulsion polymerizing the monomer starting material in the art disclosed herein, supplementary polymerization initiator is fed to the contents of the reaction vessel (reaction mixture) after an interval following completion in the feeding of the monomer starting material to the reaction vessel. By feeding supplementary polymerization initiator (also referred to below as “supplementary initiator”) in this way, the amount of monomer remaining in the reaction mixture can be effectively reduced (typically, the polymerization of such remaining monomer is made to proceed). In this way, it is possible to obtain an acrylic polymer capable of forming a PSA layer having lower TVOC emissions. The supplementary initiator used may be the same as or different from the polymerization initiator used earlier in the monomer starting material polymerization reaction (e.g., the polymerization initiator charged into the reaction vessel before completion of the feeding of the monomer starting material; referred to below as the “main initiator”). A supplementary initiator capable of efficiently reducing the amount of remaining monomer may be advantageously selected from among polymerization initiators having a lower half-life temperature (e.g., initiators selected from among azo-type polymerization initiators, persulfates, peroxide-type polymerization initiators, etc.) than the main initiator (e.g., an initiator selected from among azo-type polymerization initiators, persulfates, peroxide-type polymerization initiators, etc.). Alternatively, it is advantageous to use a redox-type polymerization initiator as the supplementary initiator. For example, preferred use may be made of a redox-type polymerization initiator by combining a peroxide (e.g., hydrogen peroxide) with ascorbic acid, combining a peroxide (e.g., hydrogen peroxide) with a ferric salt, or combining a peroxide (e.g., ammonium peroxide) with sodium bisulfite. Of these, a combination of hydrogen peroxide (typically, used in the form of an aqueous hydrogen peroxide solution having a concentration of from about 1 to about 35%) with ascorbic acid is preferred because excess residue does not arise following the redox reaction. The amount of supplementary initiator is not subject to any particular limitation. For example, it may be used in a range of from about 0.005 to about 1 part by weight per 100 parts by weight of the monomer starting material.

The preferred timing for feeding (adding) such supplementary initiator to the reaction mixture will vary depending on the type of supplementary initiator. Such addition is preferably carried out after some interval (typically after about 10 minutes to about 4 hours, such as from about 1 to about 3 hours, have elapsed) following completion of the feeding of the monomer starting material to the reaction vessel, but before cooling of the reaction mixture ends. For example, in the case of a supplementary initiator of a type which reduces the remaining monomer by decomposing under heat to generate a radical (e.g., azo-type polymerization initiators, persulfates, and peroxide-type polymerization initiators), it is preferable to add the supplementary initiator during the maturation period (e.g., at a point in time when about 30 to 95% of the maturation time has elapsed). Alternatively, in cases where a redox-type supplementary initiator is used, preferred use may be made of an embodiment in which the supplementary initiator is added at about the end of the maturation time (e.g., an embodiment in which cooling is begun at substantially the same time that the supplementary initiator is charged) or during cooling of the reaction mixture. In this way, the amount of remaining monomer can be effectively reduced while holding down the adverse effects on productivity. Addition of the supplementary initiator may be carried out all at once, or may be carried out continuously or in divided portions. Because the operation is simple, preferred use may be made of an embodiment in which the supplementary initiator is added all at once.

In such emulsion polymerization, because the use of supplementary initiator enables the amount of remaining monomer to be efficiently reduced, an acrylic polymer emulsion in which the amount of remaining monomer has been adequately reduced can be achieved without making the polymerization time too long (e.g., even at a polymerization time of about 8 hours or less). With a PSA composition obtained by adding a tackifying resin to such an acrylic polymer emulsion, it is possible to form a PSA layer in which the toluene emissions and TVOC emissions have been dramatically reduced. The ability to lower in this way the level of VOCs in PSA without requiring an excessively long polymerization time is advantageous from the standpoint of enhancing the productivity of PSA compositions and of PSA sheets manufactured using such compositions.

A polymerization mixture in the form of an emulsion of acrylic polymer dispersed in water (acrylic polymer emulsion) can be obtained by means of such emulsion polymerization. Preferred use may be made of this polymerization mixture, or of such a polymerization mixture that has been suitably post-treated, as the water-dispersed acrylic polymer in the art disclosed herein. Alternatively, use may be made of a water-dispersed acrylic polymer prepared by employing a polymerization method other than emulsion polymerization (e.g., solution polymerization, photopolymerization, bulk polymerization) to synthesize an acrylic polymer, then dispersing the acrylic polymer in water.

If necessary, an emulsifier may be used in preparing the water-dispersed acrylic polymer. Use may be made of an anionic, nonionic or cationic emulsifier for this purpose. Generally, the use of an anionic or nonionic emulsifier is preferred. Advantageous use may be made of such an emulsifier when, for example, emulsion polymerizing the monomer ingredients or when dispersing an acrylic polymer obtained by another method in water. The amount of emulsifier is not subject to any particular limitation, provided it is an amount capable of preparing the acrylic polymer in the form of an emulsion. For example, the amount is suitably selected from a range of about 0.2 to about 10 parts by weight (preferably about 0.5 to about 5 parts by weight), solids basis, per 100 parts by weight of the acrylic copolymer.

In addition to such an acrylic polymer, the PSA composition in the art disclosed herein may also include a tackifying resin. Tackifying resins that may be used for this purpose include, but are not limited to, rosin, terpene, hydrocarbon, epoxy, polyimide, elastomer, phenol and ketone-type tackifying resins. Such tackifying resins may be used singly or as combinations of two or more thereof.

Illustrative examples of rosin-type tackifying resins include unmodified rosins (raw rosins) such as rubber rosin, wood rosin and tall oil rosin; modified rosins obtained by hydrogenating, disproportionating, polymerizing or otherwise modifying these unmodified rosins (e.g., hydrogenated rosin, disproportionated rosin, polymerized rosin, and rosins that have been chemically modified in some other way); and other types of rosin derivatives. Examples of such rosin derivatives include rosin esters such as unmodified rosins that have been esterified with alcohols (i.e., esterification products of rosins), and modified rosins (e.g., hydrogenated rosins, disproportionated rosins, polymerized rosins) that have been esterified with alcohols (i.e., esterification products of modified rosins); unsaturated fatty acid-modified rosins obtained by modifying unmodified rosins or modified rosins (e.g., hydrogenated rosins, disproportionated rosins, polymerized rosins) with an unsaturated fatty acid; unsaturated fatty acid-modified rosin esters obtained by modifying rosin esters with an unsaturated fatty acid; rosin alcohols obtained by reduction treatment of the carboxyl groups in unmodified rosins, modified rosins (e.g., hydrogenated rosins, disproportionated rosins, polymerized rosins), unsaturated fatty acid-modified rosins or unsaturated fatty acid-modified rosin esters; metal salts of rosins (especially rosin esters) such as unmodified rosins, modified rosins or various types of rosin derivatives; and rosin phenol resins obtained by thermal polymerization involving the addition of phenol to a rosin (e.g., unmodified rosin, modified rosin, various types of rosin derivatives) using an acid catalyst.

Illustrative examples of terpene-type tackifying resins include terpene resins such as α-pinene polymers, β-pinene polymers and dipentene polymers; and modified terpene resins obtained by modifying (e.g., phenolic modification, aromatic modification, hydrogenation, hydrocarbon modification) such terpene resins. Illustrative examples of such modified terpene resins include terpene-phenol resins, styrene-modified terpene resins, aromatic modified terpene resins and hydrogenated terpene resins.

Hydrocarbon-type tackifying resins include various types of hydrocarbon resins, such as aliphatic hydrocarbon resins, aromatic hydrocarbon resins, alicyclic hydrocarbon resins, aliphatic aromatic petroleum resins (e.g., styrene-olefinic copolymers), aliphatic alicyclic petroleum resins, hydrogenated hydrocarbon resins, coumarone resins and coumarone-indene resins. Examples of aliphatic hydrocarbon resins include one or more aliphatic hydrocarbon polymer selected from among olefins and dienes having about 4 or 5 carbons. Examples of olefins include 1-butene, isobutylene and 1-pentene. Examples of dienes include butadiene, 1,3-pentadiene and isoprene. Examples of aromatic hydrocarbon resins include polymers of vinyl group-containing aromatic hydrocarbons having about 8 to 10 carbons (e.g., styrene, vinyltoluene, α-methylstyrene, indene, methylindene). Examples of alicyclic hydrocarbon resins include: alicyclic hydrocarbon resins obtained by the cyclic dimerization of what is referred to as the “C4 petroleum fraction” or “C5 petroleum fraction,” followed by polymerization; polymers of cyclic diene compounds (e.g., cyclopentadiene, dicyclopentadiene, ethylidene norbornene, dipentene), or hydrogenation products thereof; and alicyclic hydrocarbon resins obtained by hydrogenating the aromatic rings of aromatic hydrocarbon resins or aliphatic-aromatic petroleum resins.

In the art disclosed herein, it is preferable to use a tackifying resin having a softening point (softening temperature) of at least about 100° C. (typically, at least about 110° C., preferably at least about 120° C., and more preferably at least about 140° C.). With a tackifying resin having such a softening point, a PSA sheet having a higher performance (e.g., in which at least the adhesiveness or the heat resistance has been further improved) can be achieved. The upper limit in the softening point of the tackifying resin is not subject to any particular limitation, and may be, for example, about 170° C. or less (preferably about 160° C. or less, and more preferably about 155° C. or less). In tackifying resins with a softening point higher than 170° C., the compatibility with the acrylic polymer may have a tendency to decrease.

The tackifying resin may be used singly or as a combination of two or more thereof. For example, use may be made of a combination of a tackifying resin having a high softening point (e.g., at least about 130° C.) with a tackifying resin having a lower softening point (e.g., one with a softening point of about 80 to 120° C.) in a suitable ratio therebetween. In this way, it is possible to enhance the low-temperature properties (e.g., adhesiveness and tack under low-temperature conditions) while minimizing the decrease in other properties. From the standpoint of properties such as cohesiveness in a high-temperature environment, it is preferable for at least about 50% of the total weight of the tackifying resin used to be a tackifying resin having a high softening point.

The tackifying resin softening point mentioned herein is defined as the value measured based on the softening point test method (ball and ring method) described in JIS K 5902 and JIS K 2207. Specifically, a specimen is rapidly melted at as low a temperature as possible, then is filled carefully, so that no bubbles form, into a ring that has been placed on a flat metal plate. After cooling, the portion which swells out from the flat plane that includes the top edge of the ring is cut away with a small, slightly heated, knife. Next, a ring support is placed in a glass vessel (heating bath) having a diameter of at least 85 mm and a height of at least 127 mm, and glycerol is poured into the vessel to a depth of at least 90 mm. Next, a steel ball (diameter, 9.5 mm; weight, 3.5 g) and the ring filled with the specimen are immersed in the glycerol so that they do not mutually touch, and the glycerol temperature is held at 20±5° C. for 15 minutes. Next, the steel ball is placed at the center on the surface of the specimen in the ring, and this arrangement (the ball on the specimen in the ring) is then set at a fixed position on the ring support. While keeping the distance from the top edge of the ring to the glycerol surface at 50 mm, a thermometer is then set in place so that the center position of the mercury bulb in the thermometer is at the same height as the center of the ring, and the vessel is heated. The flame of the Bunsen burner used for heating is brought against the center and edge at the bottom of the container so that heating is uniform. The rate of rise in the bath temperature from the start of heating until a temperature of 40° C. has been reached must be 5.0±0.5° C. per minute. The specimen gradually softens and flows down from the ring, eventually touching the bottom plate, at which time the temperature is read off. This is used as the softening point. Measurement of the softening point is carried out simultaneously on at least two specimens, and the average of the readings is used.

This type of tackifying resin may be advantageously used in the form of an emulsion prepared by dispersing the resin in water (tackifying resin emulsion). For example, by mixing an aqueous emulsion of an acrylic polymer with an aqueous emulsion of the tackifying resin, a PSA composition containing these ingredients in the desired proportions can easily be prepared. It is preferable to use a tackifying resin emulsion which, at the very least, contains substantially no aromatic hydrocarbon solvent (and more preferably contains substantially no aromatic hydrocarbon solvents or other organic solvents). In this way, a PSA layer having even lower toluene emissions can be provided.

If necessary, the tackifying resin emulsion may be prepared using an emulsifier. The emulsifier may be of one or more type suitably selected from among emulsifiers similar to those which can be used in preparing the acrylic polymer emulsion. The amount of emulsifier is not subject to any particular limitation, provided it is an amount capable of preparing the tackifying resin in the form of an emulsion. For example, the amount of emulsifier may be selected from a range of about 0.2 to about 10 parts by weight (preferably from 0.5 to 5 parts by weight) per 100 parts by weight (solids basis) of the tackifying resin.

Examples of tackifying resin emulsions that may be preferably used in the art disclosed herein include that available under the trade name SK-253NS (produced by Harima Chemicals, Inc.; softening point, 145° C.; a tackifying resin-containing emulsion produced without the use of substantially any organic solvent), and that available under the trade name Tamanol E-200-NT (produced by Arakawa Chemical Industries, Ltd.; softening point, 150° C.; a tackifying resin-containing emulsion produced using an alicyclic hydrocarbon-type organic solvent).

In the art disclosed herein, the amount of tackifying resin included in the acrylate polymer is not subject to any particular limitation, and may be suitably set according to the target adhesive performance (e.g., rough surface adhesion, adhesion to low polarity materials such as polyolefins). The tackifying resin (solids basis) may be used in a proportion of from about 5 to about 100 parts by weight (preferably from about 10 to about 80 parts by weight, and more preferably from about 15 to about 60 parts by weight, such as from about 20 to about 40 parts by weight) per 100 parts by weight of the acrylic polymer. If the amount of tackifying resin is too low, the adhesion (e.g., adhesion to a rough surface or a poorly bondable adherend such as a polyolefin member) improving effects by addition of the PSA resin may be difficult to fully achieve. On the other hand, if the amount of tackifying resin is too high, the compatibility with the acrylic polymer tends to be inadequate, or a decline in the low-temperature properties may occur. Also, to achieve large reductions in the toluene emissions and TVOC emissions of the PSA layer (and in turn the PSA sheet), it is desirable to avoid the use of excessive tackifying resin.

If necessary, a crosslinking agent may be included in the PSA composition. The type of crosslinking agent used is not subject to any particular limitation, and may be suitably selected from among known or conventional crosslinking agents (e.g., isocyanate-type crosslinking agents, epoxy-type crosslinking agents, oxazoline-type crosslinking agents, aziridine-type crosslinking agents, melamine-type crosslinking agents, peroxide-type crosslinking agents, urea-type crosslinking agents, metal alkoxide-type crosslinking agents, metal chelate-type crosslinking agents, metal salt-type crosslinking agents, carbodiimide-type crosslinking agents, and amine-type crosslinking agents). The crosslinking agent may be used singly or as a combination of two or more thereof. The amount of the crosslinking agent is not subject to any particular limitation, and may be selected from a range of up to about 20 parts by weight (e.g., from about 0.005 to about 20 parts by weight, and preferably from about 0.01 to about 10 parts by weight) per 100 parts by weight of the acrylic polymer. Instead of using such a crosslinking agent, or in addition to using such a crosslinking agent, the PSA may be crosslinked by irradiation with active energy rays such as an electron beam or ultraviolet light.

If necessary, the PSA composition may include an acid or base (e.g., ammonia water) used for such purposes as pH adjustment. Examples of other optional ingredients that may be included in the composition include various common additives in the field of aqueous PSA compositions, such as viscosity modifiers (thickeners, etc.), leveling agents, release modifiers, plasticizers, softeners, fillers, colorants (pigments, dyes, etc.), surfactants, antistatic agents, preservatives, antidegradants, ultraviolet absorbers, antioxidants and light stabilizers.

The PSA layer in the art disclosed herein may be produced by various methods. For example, in cases where the PSA layer is of a double-sided adhesive type and is in the form of a double-sided PSA sheet with substrate, a double-sided PSA sheet having PSA on each side of the substrate may be formed by using a method selected from among the following: a method wherein the PSA composition is applied directly to a non-releasable substrate, both to a first surface and a second surface of the substrate, then dried or cured to form a film-like PSA (PSA film) on the substrate (direct method); and a method wherein a PSA film formed on a release face of a release liner is attached to the substrate, and the PSA film is transferred to the substrate (transfer method). Alternatively, in cases where the PSA layer is a double-sided adhesion type in the form of a substrate-less double-sided PSA sheet, the PSA layer can be formed on the release face of a release liner by directly applying the PSA composition to the release face, then drying or curing. In cases where the PSA layer is a single-sided adhesive type and the back face of the PSA layer is bonded to the non-release face of a backing sheet (substrate), preferred use may be made of the above direct method or transfer method as the PSA layer forming method.

When applying the PSA composition (typically, by coating), use may be made of a conventional coater (e.g., gravure roll coater, reverse roll coater, kiss roll coater, dip roll coater, bar coater, knife coater, spray coater). The thickness of the PSA layer is not subject to any particular limitation, and may be, for example, from about 2 μm to about 200 μm (preferably from about 5 μm to about 100 μm).

In the PSA product disclosed herein, the backing sheet disposed on the back face of the PSA layer (which backing sheet encompasses both backing sheets whose front face, i.e., the surface on the PSA layer side, is a release face, and backing sheets whose front face is a non-release face) may be, for example, a plastic film such as a polyolefin (e.g., polyethylene, polypropylene, ethylene-propylene copolymer) film, a polyester (e.g., polyethylene terephthalate) film, a vinyl chloride resin film, a vinyl acetate resin film, a polyimide resin film, a polyamide resin film, a fluororesin film, or cellophane; a type of paper, such as Japanese paper, kraft paper, glassine, wood-free paper, synthetic paper or topcoated paper; a woven or nonwoven fabric composed of any of various types of fibrous substances (whether natural fibers, semi-synthetic fibers, or synthetic fibers, examples of which include cotton fibers, staple fibers, Manila hemp, pulp, rayon, acetate fibers, polyester fibers, polyvinyl alcohol fibers, polyamide fibers and polyolefin fibers), either singly or as a blend; a rubber sheet made of, e.g., natural rubber or butyl rubber; foam sheets made of foam such as expanded polyurethane or expanded polychloroprene rubber; a metal foil such as aluminum foil and copper foil; or a composite thereof. The plastic film may be of an unoriented type or an oriented (monoaxially oriented or biaxially oriented) type. The backing sheet may optionally include various additives, such as fillers (e.g., inorganic fillers, organic fillers), antidegradants, antioxidants, ultraviolet absorbers, antistatic agents, lubricants, plasticizers, and colorants (e.g., pigments, dyes). The backing sheet may be in the form of a single layer, or may be in the form of a laminate. The thickness of the backing sheet may be suitably selected according to the intended object. It is generally desirable to set the thickness to, for example, from about 10 μm to about 500 μm.

As a backing sheet of a type where at least one surface (the front face and/or back face) is a release face, preferred use may be made of a backing sheet subjected to release treatment (typically, a release treatment layer has been provided by means of a release treatment agent). To form the release treatment layer, use may be made of a known or conventional release treatment agent (examples of which include silicone, fluorochemical, and long-chain alkyl-type release treatment agents). In the case of backing sheets made of a low-adhesion material such as a fluoropolymer (e.g., fluororesins such as polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer) or a low-polarity polymer (e.g., olefin resins such as polyethylene and polypropylene), the surface of the sheet may be used as a release face without applying any particular release treatment. Alternatively, the surface of a backing sheet made of a low-adhesion material may be additionally subjected to release treatment.

As a backing sheet of a type where at least the front face is a release face (release liner), preferred use may be made of paper (e.g., wood-free paper, and glassine are suitable) at least the front face (the face on the PSA layer side) of which has been laminated with polyethylene and the surface of which has been subjected to release treatment with a silicone release treatment agent (silicone treatment). Examples of more preferred backing sheets include paper laminated with polyethylene on both the front and back faces, then subjected to silicone treatment on at least the front face. By laminating the back face of the paper with polyethylene, the backing sheet (especially the paper making up the sheet) can be prevented from absorbing moisture and wrinkling, thus enabling the marks on the back face to be displayed in a readily visible manner even with the passage of time or when the humidity rises.

In cases where the PSA product disclosed herein is constructed so as to include a single-sided adhesive-type PSA sheet, a known or conventional surface treatment, such as corona discharge treatment, plasma treatment or coating of a primer, may be carried out to increase anchorability of the PSA to the front face (non-releasable surface) of the backing sheet in the PSA sheet.

Alternatively, in cases where the PSA layer disclosed herein is constructed as a double-sided PSA sheet with substrate, the substrate (non-releasable substrate) may be suitably selected and used from among a similar range of possibilities as the exemplary backing sheets mentioned above (e.g., various types of plastic films, papers, fabrics, rubber sheets, foam sheets, metal foils, and composites thereof). Preferred examples include papers and fabrics (e.g., nonwoven fabric).

### EXAMPLES

Several examples of the invention are described below, although these examples are not intended to limit the scope of the invention. In the description that follows, unless noted otherwise, all references to “parts” and “%” are based on the weight of non-volatiles.

### Example 1

A reaction vessel equipped with a condenser, a nitrogen inlet, a thermometer and a stirrer was charged with 35 parts of ion-exchanged water, and stirred at 60° C. for more than one hour under nitrogen gas flow. Next, 0.1 part of 2,2′-azobis[N-(2-carboxyethyl)-2-methylpropionamidine] hydrate (a polymerization initiator; product available under the trade name VA-057 from Wako Pure Chemical Industries, Ltd. was used) was added to the reaction vessel. While maintaining the system at 60° C., a monomer emulsion was gradually added thereto in a dropwise manner over 4 hours, thereby causing the emulsion polymerization reaction to proceed. The monomer emulsion used here was one that had been obtained by adding 90 parts of n-butyl acrylate (BA), 10 parts of 2-ethylhexyl acrylate (2EHA), 4 parts of acrylic acid (AA), 0.05 part of dodecanethiol (chain transfer agent) and 2 parts of sodium polyoxyethylene lauryl sulfate (emulsifier) to 40 parts of ion-exchanged water and emulsifying. After dropwise addition of the monomer emulsion was completed, the system was held at 60° C. for another 2 hours, then 0.1 part of ascorbic acid and 0.1 part of 35% hydrogen peroxide solution (supplementary polymerization initiator) were added. The system was cooled to room temperature, following which the pH was adjusted to 7 by the addition of 10% ammonia water, thereby giving an acrylic polymer emulsion (water-dispersed acrylic polymer).

Thirty parts of a tackifying resin emulsion (solids basis) was added to the acrylic polymer emulsion per 100 parts of the acrylic polymer included in the emulsion and uniform stirring and mixing were carried out, thereby preparing an aqueous emulsion-type PSA composition. The tackifying resin emulsion used here was a product available under the trade name SK-253NS (an aqueous emulsion of a polymerized rosin resin having a softening point of 145° C.) from Harima Chemicals, Inc. This SK-253NS was a tackifying resin emulsion produced without the use of substantially any organic solvent.

The mark “Low VOCs” was printed on one side of wood-free paper at fixed intervals in 14-point Century Gothic font using a green ink (available from Sakata Inx Corporation under the trade name Wraptone; hue: green). By changing the spacing intervals between these marks, a total of eight types of printed paper having different ink deposition ratios (print surface area ratios) of the surface area on one side of wood-free paper in a range of from 2 to 47% were produced. The print surface area ratio was determined by photographing the printed paper with a digital camera, converting the resulting image to monochrome and digitizing the monochrome image, then calculating the print surface area ratio using commercial image processing software (available under the trade name Winroof from Mitani Corporation).

Polyethylene was laminated onto both the printed face (back face) of each of these printed papers and the face on the opposite side (front face), in addition to which silicone treatment was applied thereto. In this way, a release liner (backing sheet) on which both the front face and the back face are release faces was produced. On the back face of this release liner, the green marks that had been printed onto one side of the wood-free paper were displayed through the polyethylene laminate covering that side.

Using two sheets of each of the total of eight types of release liners produced above, PSA products were manufactured in a form wherein each adhesive face of a double-sided PSA sheet with substrate is protected with a release liner. That is, the PSA composition was coated onto the front face of a first release liner and dried at 100° C. for 2 minutes to form a PSA film having a thickness of about 60 μm. A PSA film having a thickness of about 60 μm was formed in the same way on a front face of a second release liner. These PSA film-bearing release liners were attached to each side of a nonwoven fabric substrate (a pulp-type nonwoven fabric having a grammage of 14 g/m², a thickness of 42 μm and a bulk density of 0.33 g/cm³; available from Daifuku Paper Manufacturing Co., Ltd. under the trade name SP Genshi-14), and the PSA was transferred to both sides of the nonwoven fabric substrate (non-releasable substrate). Both adhesive faces of this double-sided PSA sheet with substrate (PSA layer) remained protected by the release liners used in producing the double-sided PSA sheet. In this way, a total of eight types of PSA products having differing print surface area ratios on the release liner were manufactured.

### Example 2

After charging a reaction vessel with 70 parts of BA, 27 parts of 2EHA, 3 parts of AA and 0.1 part of 2-hydroxyethyl acrylate, and also with 0.2 part of 2,2′-azobisisobutyronitrile (AIBN) as a polymerization initiator and ethyl acetate as a polymerization medium, solution polymerization was carried out at 70° C. for 8 hours, thereby giving an ethyl acetate solution of an acrylic polymer having a weight-average molecular weight of 70×10⁴. To this solution was added, per 100 parts of the acrylic polymer present within the solution: 20 parts of a tackifying resin (a polymerized rosin ester resin having a softening point of 128° C.; available under the trade name Rikatack PCJ from Rikatack) and 2 parts of a crosslinking agent (an isocyanate crosslinking agent available under the trade name Coronate L from Nippon Polyurethane Industry Co., Ltd.). The ingredients were uniformly stirred and mixed, thereby preparing a solvent-based PSA composition. Aside from using this solvent-based PSA composition, a total of eight types of PSA products in which the release lines had different print surface area ratios were manufactured in the same manner as Example 1.

The toluene emissions and TVOC emissions per gram of PSA layer (here, a double-sided PSA sheet with substrate) were measured by the methods described above for each of the PSA products manufactured in Examples 1 and 2. About 0.91 g of PSA was included per gram in each of the double-sided PSA sheets. As a result, the PSA products obtained in Example 1 were each confirmed to have in the PSA layer toluene emissions of from 2 to 3 μg/g and TVOC emissions of from 35 to 45 μg/g. The PSA products obtained in Example 2 were each confirmed to have toluene emissions of from 2 to 3 μg/g and TVOC emissions of from 200 to 250 μg/g.

The eight types of backing sheets produced in Example 1 were cut to sizes of 10 cm×10 cm, and these specimens were affixed at approximately eye-level positions to a vertical wall so that the side on which the printed images are displayed (the back face) was on the outside. Individuals having a visual acuity of 1.0 stood at a position 10 m from the wall, looked at the back face of the backing sheet, and judged whether the color of the marks could be identified. The results are shown in Table 1. Cases in which the color of the marks was identifiable were rated as “Good,” and cases in which the color was not identifiable were rated as “NG.”

TABLE 1

| | Print surface area ratio (%) | | | | | | | |
|---|---|---|---|---|---|---|---|---|
| | 2 | 4 | 6 | 8 | 11 | 17 | 34 | 47 |
| Identifiability | NG | NG | good | good | good | good | good | good |

Good: Could be identified
NG: Could not be identified

As shown in Table 1, by setting the print surface area ratio to at least 5% (specifically, at least 5% but not more than 50%), the color of the marks is easily identifiable even from a distance of 10 m. The excellent identifiability from such a distance means that when a roll of the PSA product is sitting on, for example, a distant table, the PSA product can be identified even from far away as being a low-VOC product, thus enabling a worker to efficiently go over to pick up the low-VOC PSA product. This makes it possible to increase the work efficiency when using the PSA product.

The embodiments disclosed in this application are to be considered in all respects as illustrative and not limiting. The scope of the invention is indicated by the appended claims rather than by the foregoing description, and all changes and modifications which come within the meaning and range of equivalency of the claims are intended to be embraced therein.

What is claimed is:

1. A pressure-sensitive adhesive product comprising:
a pressure-sensitive adhesive layer having an adhesive face capable of attaching to an adherend; and
a backing sheet disposed on a back face of the pressure-sensitive adhesive layer,
such that the pressure-sensitive adhesive layer produces toluene emissions when heated at 80° C. for 30 minutes of at most 20 μg per gram of the pressure-sensitive adhesive layer and produces total volatile organic compound emissions when heated at 80° C. for 30 minutes of at most 300 μg per gram of the pressure-sensitive adhesive layer, and the backing sheet has a mark in a color selected from green and blue displayed on a back face thereof.

2. The pressure-sensitive adhesive product according to claim 1, wherein the mark comprises a combination of the color with a letter, image or symbol, or a combination thereof, which indicates a low level of the volatile organic compound emissions.

3. The pressure-sensitive adhesive product according to claim 1, wherein the mark is green.

4. The pressure-sensitive adhesive product according to claim 1, wherein the mark has a surface area which accounts for at least 5% but not more than 80% of a surface area of the back face of the backing sheet.

5. The pressure-sensitive adhesive product according to claim 1, wherein the pressure-sensitive adhesive layer is formed from a water-dispersed pressure-sensitive adhesive composition.

6. The pressure-sensitive adhesive product according to claim 1, wherein the backing sheet has a front face that functions as a release face from which the back face of the pressure-sensitive adhesive layer is releasable, and the pressure-sensitive adhesive layer is a double-sided pressure-sensitive adhesive sheet comprising a non-releasable substrate having on each side thereof a pressure-sensitive adhesive.
